(19) United States
(12) Patent Application Publication
(10) Pub. No.: US 2014/0139414 A1
(43) Pub. Date: May 22, 2014

(54) Liquid Crystal Display Panel and Liquid Crystal Display Device

(71) Applicant: Xin Zhang, Shenzhen City (CN)

(72) Inventor: Xin Zhang, Shenzhen City (CN)

(73) Assignee: Shenzhen China Star Optoelectronics Technology Co. Ltd., Shenzhen, Guangdong (CN)

(21) Appl. No.: 13/805,661

(22) PCT Filed: Dec. 3, 2012
(86) PCT No.: PCT/CN12/85737

§ 371 Date: Dec. 20, 2012

(30) Foreign Application Priority Data
Nov. 22, 2012 (CN) 201210479198.7

(51) Int. Cl. G09G 3/36

(52) U.S. Cl. CPC G09G 3/3611
USPC 345/87

(57) ABSTRACT

The present invention discloses an LCD panel and an LCD device. The LCD panel includes a plurality of shift registers, a scan line including a plurality of a first scan lines and a plurality of a second scan lines, and a plurality of pixel unit sets. In each pixel unit set, the first row of the pixel units couples to the first scan lines, the m row of the pixel units couples to the (m−1)th of the second scan lines, and the M−1 second scan lines respectively couples to the first scan lines via M−1 shift registers where M and m are integer over 1, and m is equal or less than than M. Therefore, the present invention lowers cost by decreasing a number of the first scan lines and that of the gate driver chips.

### BACKGROUND OF THE INVENTION

1. Field of the Invention

The present invention relates to a display technology field, more particularly, to a liquid crystal display (LCD) panel and an LCD device.

2. Description of the Prior Art

Please refer to FIG. 1, FIG. 1 shows a structure diagram of a conventional LCD panel. The LCD panel 10 in the prior art comprises a gate driver chip 11, a plurality of rows of pixel units 12 and a plurality of scan lines 13, a number of rows of pixel units 12 and a number of scan lines 13 are identical for each row of pixel units 12 couples to a gate driver chip 11 through a scan line 13.

For reducing cost, a width of the gate driver chip 11 is around 42 millimeter in general. The width of a display area of the LCD panel 10, however, is hundreds of millimeters in general. Therefore, the scan lines 13 from the gate driver chip 11 had to extend through a sector area 14 (shown in FIG. 1) to enlarge an interval. The height of the sector area 14, generally 5 to 10 millimeter, depends on the number of the scan lines 13 and the interval of the scan lines 13 in the sector area 14. In hence, it is necessary to narrow down the interval of the scan lines 13 in the sector area 14 in the condition of a large number of the scan lines 13 so that it enhances producing difficulty and easily interferes signals among the scan lines 13 with narrower interval to deteriorate display quality.

### SUMMARY OF THE INVENTION

It is therefore a primary object of the present invention to provide an LCD panel and an LCD device for lessening a number of scan lines in a sector area and that of gate driver chips to lower producing difficulty and cost by decreasing the number of scan lines horn the gate driver chip

According the present invention, an LCD panel comprises a gate driver chip for producing scan signals, a plurality of shift registers for delaying the scan signals, a plurality of scan lines for transmitting the scan signals, and a plurality of pixel unit sets. The plurality of scan lines comprise a plurality of a first scan lines coupled to the gate driver chip and a plurality of a second scan lines. Each pixel unit set comprises M rows of pixel units and is electrically connected to one of the first scan lines and M-1 second scan lines. The pixel units on a first row couple to the first scan line. The pixel units on the mth row couple to the (m−1)th second scan lines. The M−1 second scan lines respectively couples to the first scan lines via the M−1 shift registers, where M and in are integer more than 1, and in equals to or is less than M. Each shift register comprises a scan signal input end and an output end. When the M is over 2, a scan signal input end of the first shift register in the M−1 shift registers couples to the first scan line. A scan signal input end of the the mth shift register in the M−1 shift registers couples to an output end of the (m−1)th shift register, and the scan signal input end of the mth shift register in the M−1 shift registers couples to the mth second scan line and the input end of the (m+1)th shift register.

In one aspect of the present invention, a range of the period t is 10-20 μs.

According the present invention, an LCD panel comprises a gate driver chip for producing scan signals, a plurality of shift registers for delaying the scan signals, a plurality of scan lines for transmitting the scan signals, and a plurality of pixel unit sets. The plurality of scan lines comprise a plurality of a first scan lines coupled to the gate driver chip and a plurality of a second scan lines. Each pixel unit set comprises M rows of pixel units and is electrically connected to one of the first scan lines and M−1 second scan lines. The pixel units on a first row couple to the first scan line. The pixel units on the mth row couple to the (m−1)th second scan lines. The M−1 second scan lines respectively couples to the first scan lines via the M−1 shift registers, where M and m are integer more than 1, and in equals to or is less than M.

In one aspect of the present invention, the shift register comprises a scan signal input end and an output end, and the scan signal input end and output end of the shift register respectively couple to the first and the second scan lines when the M equals to 2.

In another aspect of the present invention, the shift register further comprises a feedback end coupled to the first scan line of next stage pixel unit sets.

In another aspect of the present invention, the shift register comprises a scan signal input end and an output end. When M is over 2, a scan signal input end of the first shift register in the M−1 shift registers couples to the first scan line. A scan signal input end of the the mth shift register in the M−1 shift registers couples to an output end of the (m−1)th shift register. The scan signal input end of the mill shift register in the M−1 shift registers couples to the mth second scan line and the input end of the (m+1)th shift register.

In another aspect of the present invention, the shift register further comprises a feedback end, and the output end of the mth shift register further couples to the feedback of the (m−1)th shift register.

In still another aspect of the present invention, the shift register comprises a clock signal input end, and an input clock signal of period t is fed to the clock signal input end of the shift register.

In yet another aspect of the present invention, a range of the period t is 10-20 μs.

According the present invention, an LCD device comprises an LCD panel. The LCD panel comprises a gate driver chip for producing scan signals, a plurality of shift registers for delaying the scan signals, a plurality of scan lines for transmitting the scan signals, and a plurality of pixel unit sets. The plurality of scan lines comprise a plurality of a first scan lines coupled to the gate driver chip and a plurality of a second scan lines. Each pixel unit set comprises M rows of pixel units and is electrically connected to one of the first scan lines and M−1 second scan lines. The pixel units on a first row couple to the first scan line. The pixel units on the mth row couple to the (m−1)th second scan lines. The M−1 second scan lines respectively couples to the first scan lines via the M−1 shift registers, where M and m are integer more than 1, and m equals to or is less than M.

In one aspect of the present invention, the shift register comprises a scan signal input end and an output end, and the scan signal input end and output end of the shift register respectively couple to the first and the second scan lines when the M equals to 2.

In another aspect of the present invention, the shift register further comprises a feedback end coupled to the first scan line of next stage pixel unit sets.

In another aspect of the present invention, the shift register comprises a scan signal input end and an output end. When M is over 2, a scan signal input end of the first shift register in the M−1 shift registers couples to the first scan line. A scan signal input end of the the mth shift register in the M−1 shift registers couples to an output end of the (m−1)th shift register. The scan signal input end of the halt shift register in the M−1 shift registers couples to the mth second scan line and the input end of the (m+1)th shift register.

In another aspect of the present invention, the shift register further comprises a feedback end, and the output end of the mth shift register further couples to the feedback of the (m−1)th shift register.

In still another aspect of the present invention, the shift register comprises a clock signal input end, and an input clock signal of period t is fed to the clock signal input end of the shift register.

In yet another aspect of the present invention, a range of the period t is 10-20 μs.

In contrast to prior art, the beneficial effect of the present invention is that the present invention arranges pixel units in the first row in each pixel unit set to couple to a first scan lines. The first scan lines connect to the gate driver chip, the pixel unit in m row connects to the (m−1)th of the second scan lines, and the M−1 second scan lines respectively connects to the first scan lines via M−1 shift registers where M and m are integer over 1, and m is equal or less than than M. Therefore, each pixel unit just needs one first scan line to provide scan signals and respectively outputs the signals to the M−1 second scan lines to drive a plurality of rows of pixel units after the M−1 shift registers delays the signals. In hence, it lowers cost by decreasing a number of the first scan lines and that of the gate driver chips.

### BRIEF DESCRIPTION OF THE DRAWINGS

For better understanding embodiments of the present invention, the following detailed description taken in conjunction with the accompanying drawings is provided. Apparently, the accompanying drawings are merely for sonic of the embodiments of the present invention. Any ordinarily skilled person in the technical field of the present. invention could still obtain other accompanying drawings without use laborious invention based on the present accompanying drawings.

FIG. 1 shows a structure diagram of a conventional LCD panel.

FIG. 2 is a structure diagram of an LCD panel according to a first embodiment of the present invention.

FIG. 3 shows the pixel unit sets and the shift registers of the LCD panel according to a second embodiment of the present invention.

FIG. 4 illustrates a structure diagram of the shift register of the LCD panel in FIG. 3.

FIG. 5 illustrates waveforms of correspondent scan signals of the LCD panel in FIG. 3.

FIG. 6 is a structure diagram of the LCD panel according to a third embodiment of the present invention.

FIG. 7 shows the pixel unit sets and the shift registers of the LCD panel of FIG. 6.

FIG. 8 illustrates waveforms of correspondent scan signals of the LCD panel in FIG. 6.

FIG. 9 is a structure diagram of the LCD device according to a fourth embodiment of the present invention.

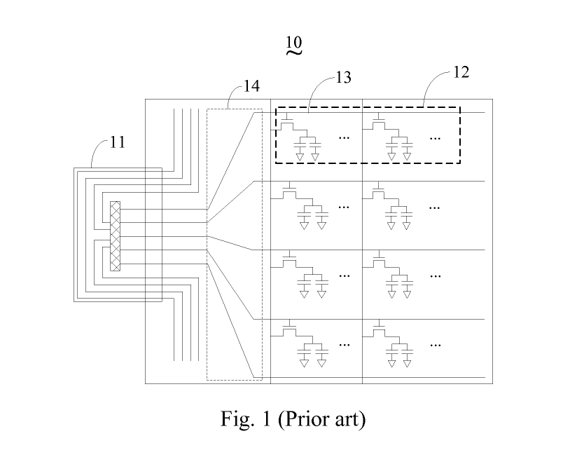

### DETAILED DESCRIPTION OF THE PREFERRED EMBODIMENTS

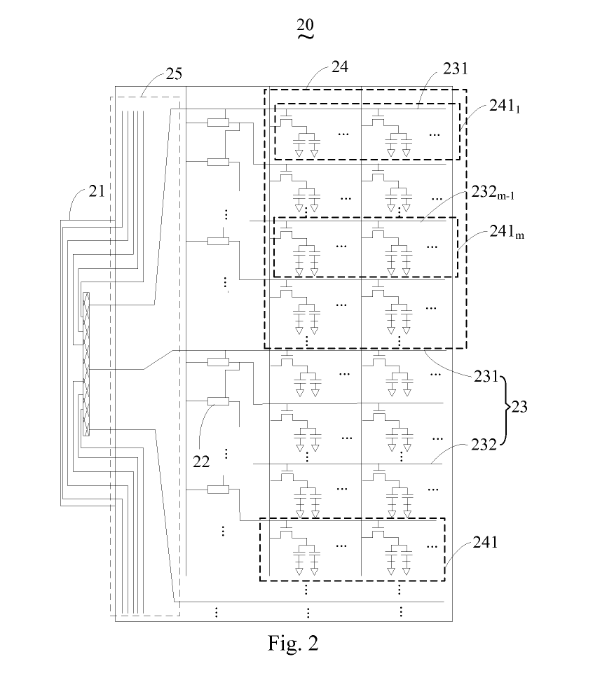

Please refer to FIG. 2, FIG. 2 is a structure diagram of an LCD panel according to a first embodiment of the present invention. As FIG. 2 shows, an LCD panel 20 comprises a gate driver chip 21, a plurality of shift registers 22. a plurality of scan lines 23 and a pluralty of pixel unit sets 24.

The gate driver chip 21 of the embodiment, set up on the LCD panel 20 by the chip on film (COF) technology, is used for generating scan signals, and a pulse of each scan signal is preferred to be 10-20 μs. The shift registers 22 are used for delaying scan signals, and the scan lines 23 are used for transmitting scan signals. The scan lines 23 of the embodiment comprise a plurality of a first scan lines 231 and a plurality of a second can lines 232. The first scan lines 231 couple to the gate driver chip 21 through a sector area 25, and more particularly, the interval between the first scan lines 231 from the gate driver chip 21 in the sector area 25 broadens. Each of the pixel unit sets 24 comprises M rows of pixel units 241 and is electrically connected to one of the first scan lines 231 and the M−1 second scan lines 232. More particularly, the pixel units in the first row 241₁ couple to the first scan lines 231, and the pixel units in the mth row 241ₘ couple to the second scan lines in the (m−1)th line 232ₘ₋₁ which respectively couple to the first scan lines 231 via M−1 shift registers 22, where M and m are integers more than 1, and m is equal or less than than M.

Compared to prior art, each pixel unit in the first row of the pixel unit sets 24 of the embodiment couples to the first scan lines, and pixel units in other rows respectively couples to the first scan lines via a plurality of shift registers. In hence, it drives a plurality of pixel units in each pixel unit set only by one of the first scan lines coupled to a gate driver chip. Therefore, it lessenes number of the first scan lines in a sector area and that of gate driver chips to lower producing difficulty and cost by decreasing the number of scan lines in the gate driver chip.

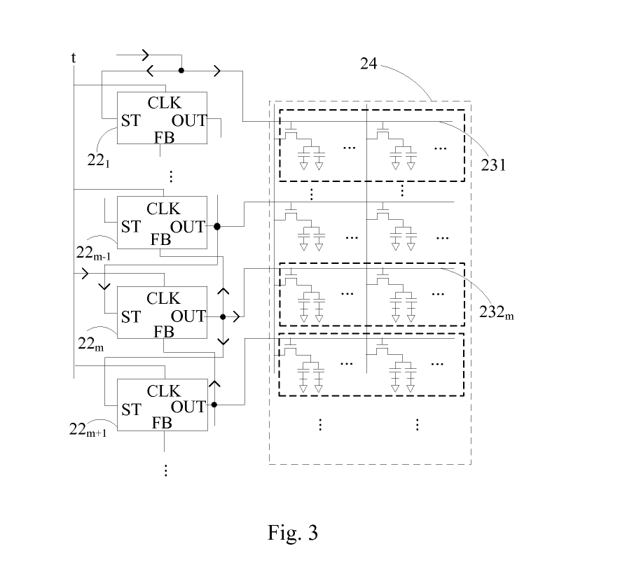

The second embodiment of the present invention is demonstrated based on the first embodiment. As FIG. 3 shows, FIG. 3 shows the pixel unit sets and the shift registers of the LCD panel according to a second embodiment of the present invention.

Each of the shift registers 22 comprises a scan signal input end ST, a scan signal output end OUT, a clock signal input end CLK and a feedback end FB. If M is more than 2, the connection way of M−1 shill registers 22 correspondent to each pixel unit set 24 is: the scan signal input end ST of the first shill register 22 couples to the first scan lines 231, the scan signal input end ST of the mth shift register 22, couples to the output end OUT of the (m−1)th shift register 22ₘ₊₁, and the output end OUT of the mth shift register 22ₘ couples to the mth second scan line 232ₘ and the input ST of the (m+1)th shift register 22ₘ₊₁. Furthermore, the output end (JUT of the mth shift register 22ₘ couples to the feedback end FB of the (m−1)th shift register 22ₘ₋₁. Therefore, the feedback end FB of the mth shift register 22ₘ couples to the output end OUT of the (m+1)th shift register 22ₘ₊₁. A clock signal having a period t is fed to the clock signal input end CLK of the shift register 22, the range of t is preferred to be 10-20 μs.

The following is an operating principle of a shill register in detail.

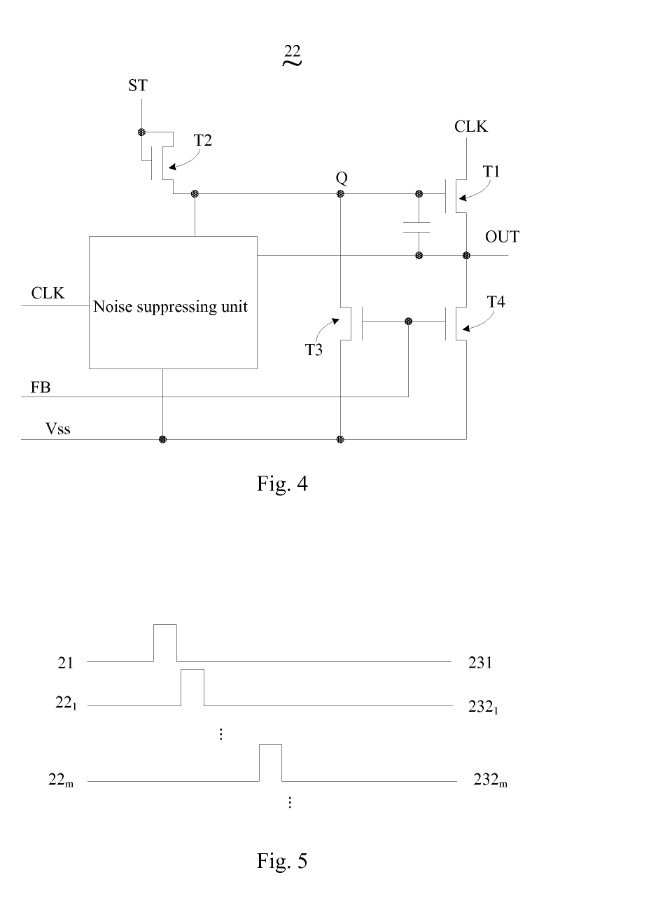

Please refer to FIG. 4, FIG. 4 illustrates a structure diagram of the shift register of the LCD panel in FIG. 3. As FIG. 4 shows, the scan signal input end ST is triggered when a scan signal is input to the scan signal input end ST of the shift register 22. As a result, the scan signal input end ST is at high level, and a transistor T2 turns on to raise potential at node Q to turn on a transistor T1, so that the output end OUT outputs a clock signal as the clock signal input end CLK is at low level. The scan signal input end ST is at low level to turn the transistor T2 off when a scan signal is not input to the scan signal input end ST. But the level at node Q and that at the clock signal input end CLK are still high so that the output end OUT outputs high level which means the output end OUT outputs a scan signal to the second scan lines 232. In the meantime, The feedback end FB receives the high level signal from the second scan lines 232 to turn transistors T3 and T4 on to lower the voltage level at the output end OUT and node Q so that it shuts the output from the output end OUT down. As a whole, a cycle of the shift register 22 is finished.

The shift register 22 delay the scan signal output to the previous scan line 23 about 10-20 μs not only because an impulse of the scan signal is preferred to be with a 10-20 μs width but also the range of the period t of the clock signal from the clock signal input end CLK of the shift register 22 is preferred to be 10-20 μs. and the next stage scan line 23 do not transmit scan signals until the previous stage scan line 23 finish the transmittance of scan signals. Please refer to FIG. 5 illustrating waveforms of correspondent scan signals of the LCD panel in FIG. 3. As FIG. 5 shows, the first scan line 231 of the pixel unit set 24 transmits the scan signals from the gate driver chip 21, the second scan lines 232₁ of the pixel unit set 24 transmits the scan signals from the first shift register 22₁, the mth second scan lines 232ₘ transmits the scan signals from the mth shift register 22,ₘ.

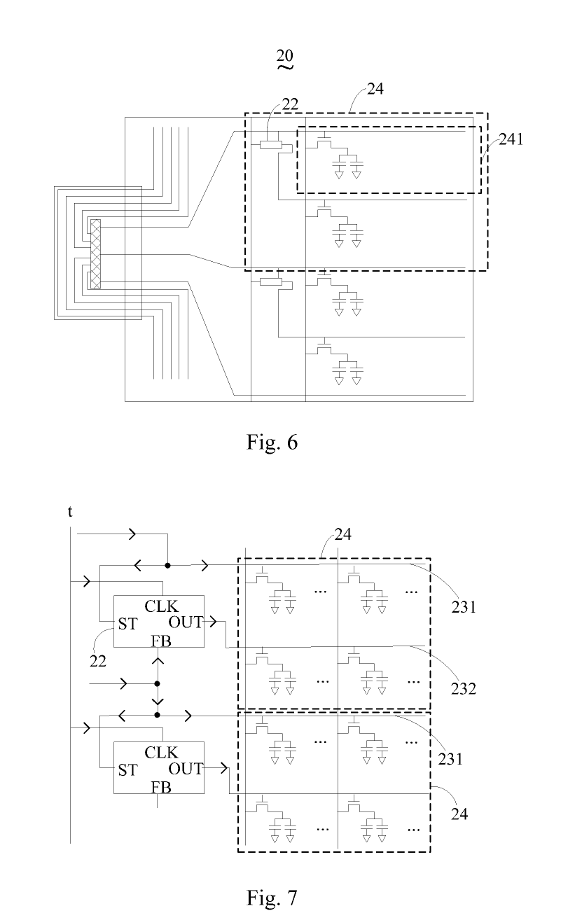

The present invention further provides a third embodiment based on the first embodiment. As FIG. 6 shows, FIG. 6 is a structure diagram of the LCD panel according to a third embodiment of the present invention.

In this embodiment, M equals to 2, indicating that each pixel unit set 24 comprises two rows of pixel units 241, and each pixel unit set 24 corresponds to one shift register 22. The specific connection relation between the shift register 22 and the pixel unit sets 24 refers to FIG. 7.

As FIG. 7 shows, each shift register 22 comprises a scan signal input end ST, an output end OUT, a clock signal input end CLK and a feedback end FB. The scan signal input end ST and the output end OUT of the shift register 22 respectively couple to the first scan line 231 and the second scan line 232. Furthermore, the feedback end FB of the shift register 22 couples to the first scan line 231 of the next pixel unit set 24. The clock signal input end CLK of the shift register 22 inputs a clock signal of period t, and the range of t is preferred to be 10-20 μs.

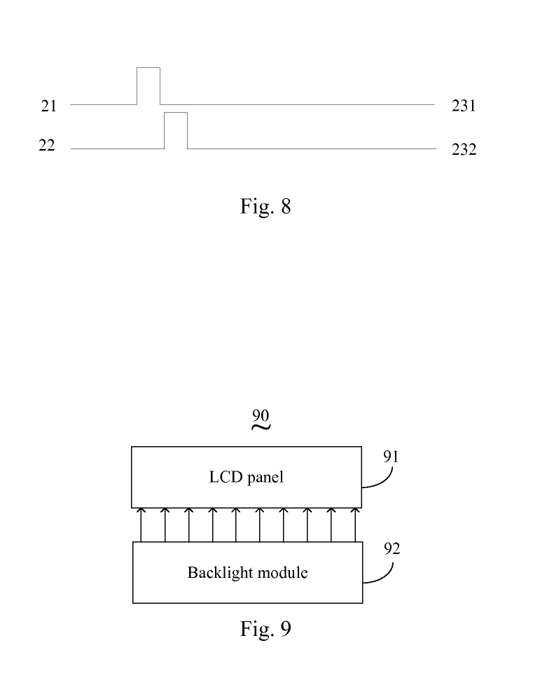

Since the impulse of scan signal is a 10-20 μs width and the range of the period t of the clock signal from the clock signal input end CLK of the shift register 22 is 10-20 μs, the shift register 22 delays the scan signal output to the previous scan line 23 about 10-20 μs. The second scan line 232 does not transmit scan signals until the first scan line 231 finishes the transmittance of scan signals. Please refer to FIG. 8 illustrating waveforms of correspondent scan signals of the LCD panel in FIG. 6. As FIG. 8 shows, the first scan line 231 of the pixel unit set 24 transmits the scan signals from the gate driver chip 21, and the second scan line 232 of the pixel unit set 24 transmits the scan signals from the shift register 22.

Please refer to FIG. 9, FIG. 9 is a structure diagram of the LCD device according to a fourth embodiment of the present invention. An LCD device 90 comprises an LCD panel 91 and a backlight module 92 for providing the LCD panel 90 a light source. There is no more description on the structure of the LCD panel 91 because it is the same with that of the LCD panel 20.

In the sum, pixel units in the first raw of each pixel unit set in the present invention couple to a first scan line, and pixel units in the rest rows respectively couple to the first scan line via a plurality of shift registers. Therefore, it drives a plurality of pixel units only by a first scan line coupled to a gate driver chip. Therefore, it lessenes a number of scan lines in a sector area and that of gate driver chips to lower producing difficulty and cost by decreasing the number of scan lines in the gate driver chip.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. An LCD panel comprising:
a gate driver chip for producing scan signals;
a plurality of shift registers for delaying the can signals;
a plurality of scan lines for transmitting the scan signals, wherein the plurality of scan lines comprise a plurality of a first scan lines coupled to the gate driver chip and a plurality of a second scan lines;
a plurality of pixel unit sets, each pixel unit set comprising M rows of pixel units and electrically connected to one of the first scan lines and M−1 second scan lines, wherein the pixel units on a first row couple to the first scan line, the pixel units on the mth row in each of the pixel unit sets couple to the (m−1)th. second scan lines, wherein the M−1 second scan lines respectively couples to the first scan lines via the M−1 shift registers, where M and in are integer more than 1, and in equals to or is less than M;
wherein each shift register comprises a scan signal input end and an output end, when the M is over 2, a scan signal input end of the first shift register in the M−1 shift registers couples to the first scan line, a scan signal input end of the the mth shift register in the M−1 shift registers couples to an output end of the (m−1)th shift register, the scan signal input end of the mth shift register in the M−1 shift registers couples to the mth second scan line and the input end of the (m+1)th shift register.

2. The LCD panel of claim 1, wherein a range of the period t is 10-20 μs.

3. An LCD panel comprising:
a gate driver chip for producing scan signals;
a plurality of shift registers for delaying the scan signals;
a plurality of scan lines for transmitting the scan signals, wherein the plurality of scan lines comprise a plurality of a first scan lines coupled to the gate driver chip and a plurality of a second scan lines:
a plurality of pixel unit sets, each pixel unit set comprising M rows of pixel units and electrically connected to one of the first scan lines and M−1 second scan lines, wherein the pixel units on a first row couple to the first scan line, the pixel units on the mth row in each of the pixel unit sets couple to the (m−1)th second scan lines, wherein the M−1 second scan lines respectively couples to the first scan lines via the M−1 shift registers, where M and m are integer more than 1, and m equals to or is less than M.

4. The LCD panel of claim 3, wherein the shift register comprises a scan signal input end and an output end, and the scan signal input end and output end of the shift register respectively couple to the first and the second scan lines when the M equals to 2.

5. The LCD panel of claim 4, wherein the shift register further comprises a feedback end coupled to the first scan line of next stage pixel unit sets.

6. The LCD panel of claim. 3, wherein the shift register comprises a scan signal input end and an output end, when the M is over 2, a scan signal input end of the first shift register in the M−1 shift registers couples to the first scan line, a scan signal input end of the the mth shift register in the M−1 shift registers couples to an output end of the (m−1)th shift register, the scan signal input end of the mth shift register in the M−1 shift registers couples to the mth second scan line and the input end of the (m+1)th shift register.

7. The LCD panel of claim 6, wherein the shift register further comprises a feedback end, and the output end of the mth shift register further couples to the feedback of the (m−1)th shift register.

8. The LCD panel of claim 3, wherein the shift register comprises a clock signal input end, and an input clock signal of period t is fed to the clock signal input end of the shift register.

9. LCD panel of claim 8, wherein a range of the period t is 10-20 μs.

10. An LCD device comprising an LCD panel, the LCD panel comprising:
a gate driver chip for producing scan signals;
a plurality of shift registers for delaying the scan signals;
a plurality of scan lines for transmitting the scan signals, wherein the plurality of scan lines comprise a plurality of a first scan lines coupled to the gate driver chip and a plurality of a second scan lines;
a plurality of pixel unit sets, each pixel unit set comprising M rows of pixel units and electrically connected to one of the first scan lines and M−1 second scan lines, wherein the pixel units on a first row couple to the first scan line, of the pixel units on the mth row in each of the pixel unit sets couple to the (m−1)th second scan lines, wherein the M−1 second scan lines respectively couples to the first scan lines via the M−1 shift registers, where M and m are integer more than 1, and in equals to or is less than M.

11. The LCD device of claim 10, wherein the shift register comprises a scan signal input end and an output end, and the scan signal input end and output end of the shift register respectively couple to the first and the second scan lines when the M equals to 2.

12. The LCD device of claim 11, wherein the shift register further comprises a feedback end coupled to the first scan line of next stage pixel unit sets.

13. The LCD device of claim 10. wherein the shift register comprises a scan signal input end and an output end, when M is over 2, a scan signal input end of the first shift register in the M−1 shift registers couples to the first scan line, a scan signal input end of the the mth shift register in the M−1 shift registers couples to an output end of the (m−1)th shift register, the scan signal input end of the mth shift register in the M−1 shift registers couples to the mth second scan line and the input end of the (m+1)th shift register.

14. The LCD device of claim 13, wherein the shift register further comprises a feedback end, and the output end of the mth shift register further couples to the feedback of the (m−1)th shift register.

15. The LCD device of claim 10, Wherein the shift register comprises a clock signal input end, and an input clock signal of period t is fed to the clock signal input end of the shift register.

16. The LCD device of claim 15, wherein a range of the period is 10-20 μs.
